(19) United States
(12) Patent Application Publication
(10) Pub. No.: US 2022/0248895 A1
(43) Pub. Date: Aug. 11, 2022

(54) ESPRESSO MACHINE CONE FILTER

(71) Applicant: Roberto Bresciani, Ferndale, WA (US)

(72) Inventor: Roberto Bresciani, Ferndale, WA (US)

(21) Appl. No.: 17/527,160

(22) Filed: Nov. 15, 2021

Related U.S. Application Data
(60) Provisional application No. 63/113,381, filed on Nov. 13, 2020.
(60) Provisional application No. 63/270,554, filed on Oct. 21, 2021.

(51) Int. Cl. A47J 31/06; B01D 29/085; B01D 39/14

(52) U.S. Cl. CPC A47J 31/0663; B01D 2239/065; B01D 39/14; B01D 29/085

(57) ABSTRACT

An espresso machine cone filter is disclosed. In one embodiment, and espresso machine cone filter includes a base having a protruding rim to fit within a portafilter, the protruding rim having a hollow under section to align with the top of the portafilter, a mesh cone filter fixed to the base on a top end, with mesh cone filter having one or more layers of mesh and a robust cap on the cone filter tip to hold the mesh in place and to provide a rigid place to tap the cone filter for removal.

### BACKGROUND

### Field of the Invention

The invention relates to a method and apparatus for brewing pour over coffee or tea in an espresso machine using a cone filter.

### BRIEF DESCRIPTION OF THE DRAWINGS

FIG. 1 is an upper perspective view of an espresso machine cone filter according to the present invention.

FIG. 2 is a top view of the espresso machine cone filter in FIG. 1.

FIG. 3 is a top cross section of a portion of one embodiment espresso machine cone filter.

FIG. 4 is a bottom view of the espresso machine cone filter in FIG. 1.

FIG. 5 is a side view of the espresso machine cone filter in FIG. 1.

FIG. 6 is a perspective view of the espresso machine cone filter in FIG. 1 in a portafilter.

FIG. 7 is a side view of the espresso machine cone filter in FIG. 1 in a portafilter.

FIG. 8 is an end view of the espresso machine cone filter in FIG. 1 in a portafilter.

FIG. 9 is a flow chart showing one example embodiment method using an espresso machine cone filter.

### DETAILED DESCRIPTION

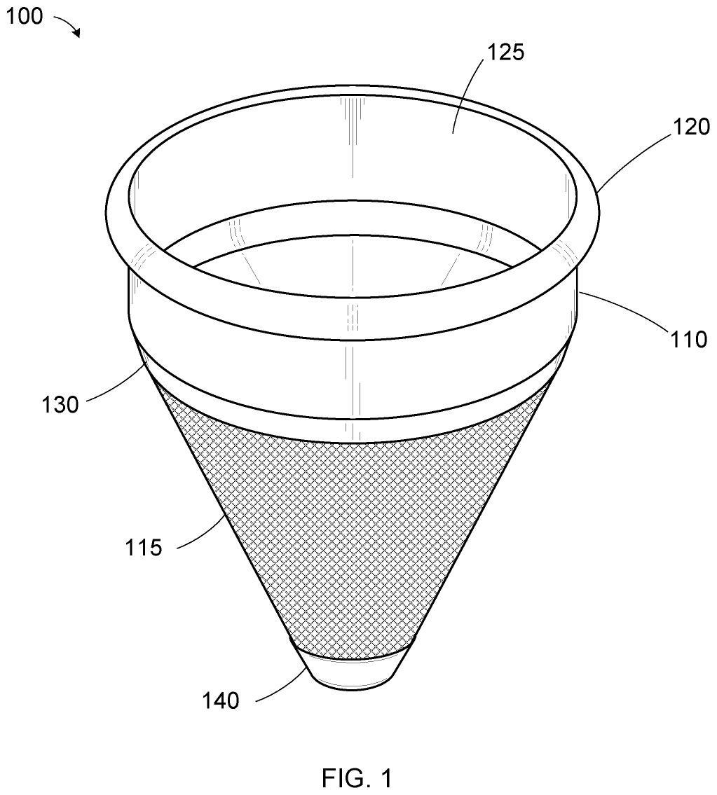

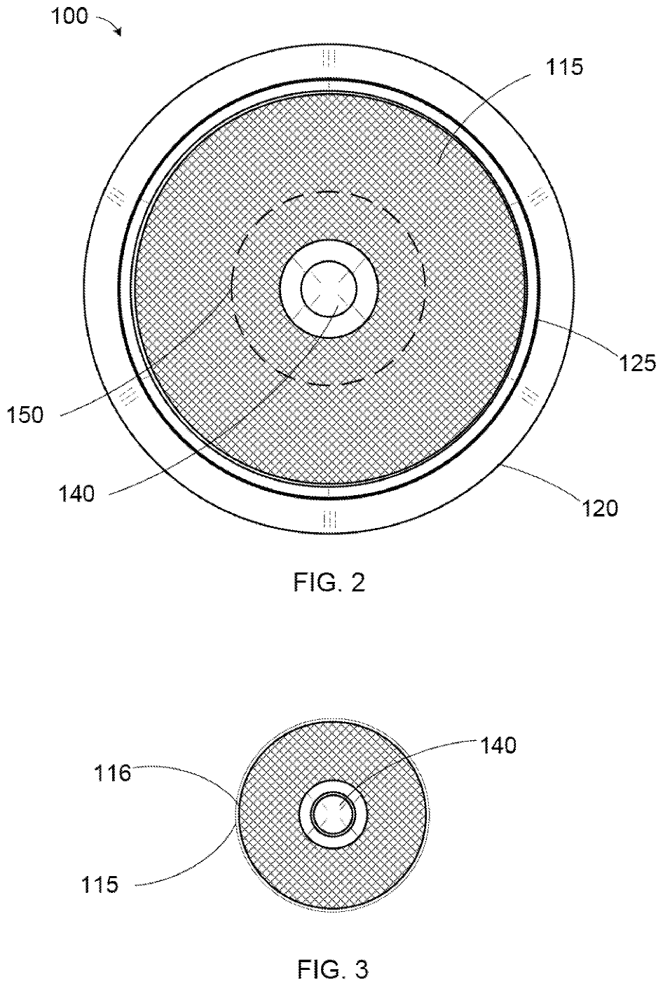

A method and apparatus for brewing pour-over style coffee and tea in an espresso machine is disclosed herein. With reference to FIG. 1, a first embodiment of an espresso machine cone filter 100 includes a cap 140, a cone filter segment 115, and a base 110. In this embodiment, the cone filter segment 115 is a mesh that is connected to the base 110 and to the cap 140. The cone filter segment may be a mesh, or have holes suitable for keeping coffee grounds or loose tea on one side to be brewed or steeped in water where the resulting coffee or tea can pass through the filter. Some embodiments may have one or more mesh layers.

In some embodiments, the cone filter segment 115 may be connected to the base 110 by welding, by adhesive, or may be fabricated in a single part with the base or otherwise sealably attached to the base 110. Conventionally, an espresso machine filter basket has a protruding rim 125 around its base that provides a secure fit inside a portafilter using a spring in the portafilter that the protruding rim 125 extends during insertion and then the spring tightens once the filter is pushed in far enough for the spring to clear the protruding rim. In this way, after espresso grounds are used in the filter basket 115 the portafilter 160 can be tapped against something to clear the old grounds out without the filter basket coming loose. This is particularly useful as a conventionally used espresso machine may be used hundreds of times in a row. Additionally, a conventional filter basket will have very fine porosity as espresso grounds are small.

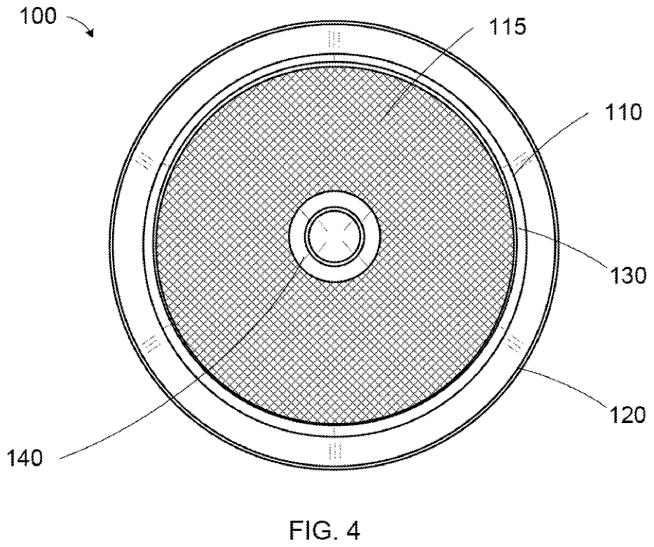

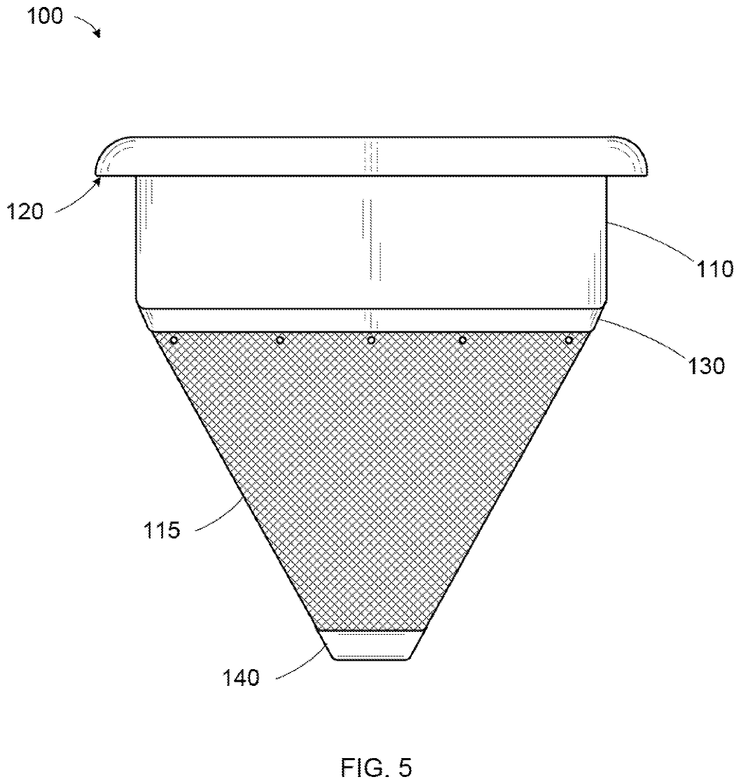

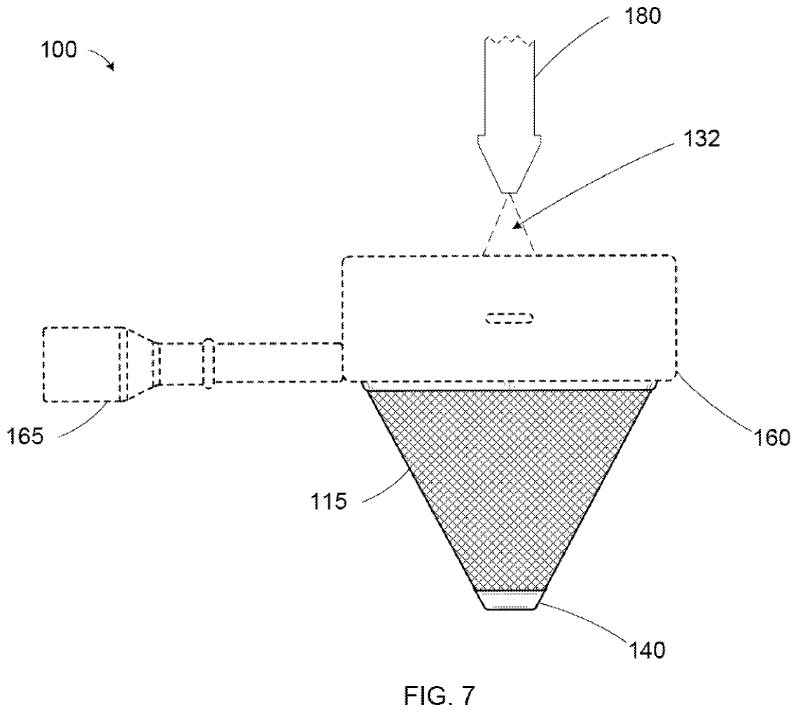

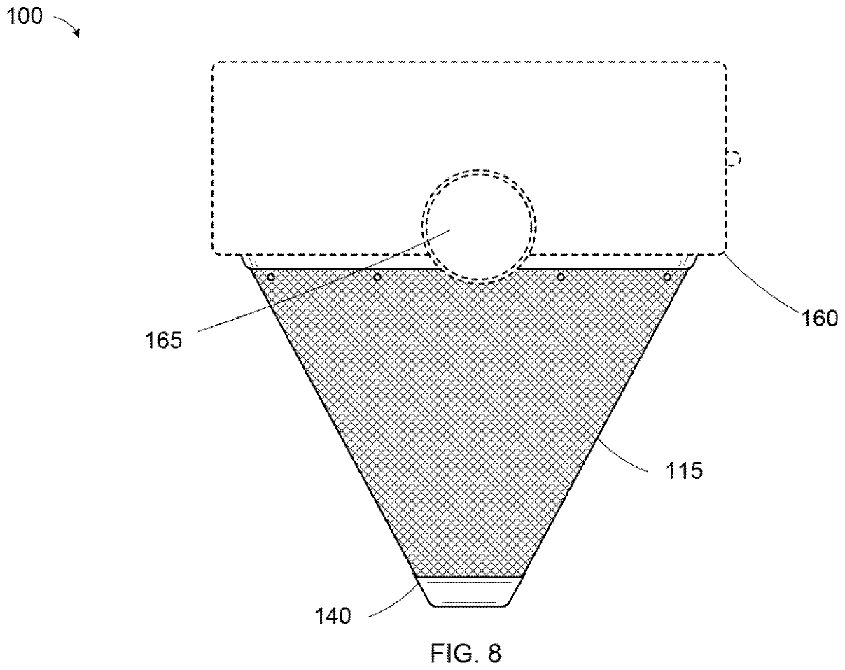

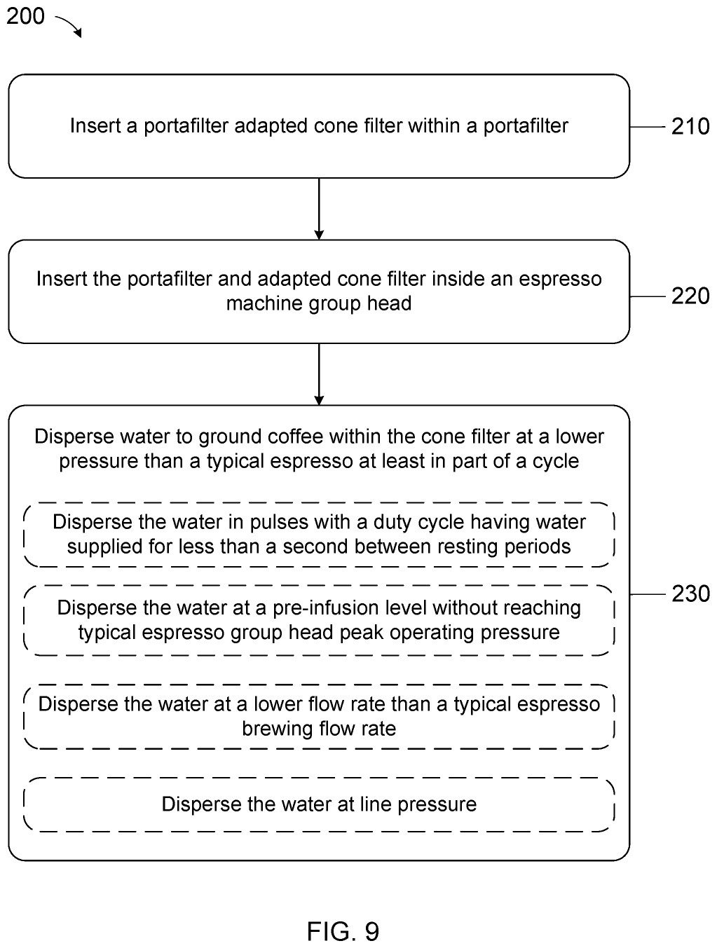

Referring to FIG. 4, the base 110 can be seen with a lip portion 125 to secure the filter into a portafilter, a cylindrical section 110 to fit within the walls of the portafilter 160, and a truncated conical section 130 for attachment to the filter section. The truncated conical section 130 allows the rigid base section to be formed to the filter section 115 in a planar fashion such that the filter 100 is not bent to form the connection and thus creates a more robust filter structure. Additionally, in the present embodiment the cylindrical section 110 does not have a protruding rim like conventional espresso filter baskets. This rimless cylindrical section allows a filter to not lock into place with the spring in the portafilter, as shown in FIGS. 5-7. A non-locking filter is beneficial for a pour-over coffee or tea application in an espresso machine as the typical use of the espresso machine will be to make espresso repeatedly and the cone filter 100 will be more readily removable than the rimmed filter basket for espresso grounds.

In the present embodiment, the mesh 115 is formed from a substantially planar mesh that is cut to a shape to fold into a truncated conical shape and be attached to itself at a seam. This allows reduced manufacturing costs. Additionally, the mesh may be in one or more layers, layers of different structural strength such as a stronger outer layer, the mesh may be formed directly into the cone filter, etc.

In some embodiments, the filter section 115 is welded to the cap 140 and the base portion 110 as well as to itself along the seam, to provide a rigid structure that allows the cone filter 100 to be removed from a portafilter by tapping the cap 140 onto a hard surface and having the rimless cylindrical section slide out of the portafilter. Preferably, the cylindrical section will fit fixedly into the portafilter 160 by having an external diameter very near the internal diameter of the portafilter, but other embodiments are not limited to this fixed attachment. For example, a cone filter 100 may fit more loosely in a portafilter 160 and be held into place between the portafilter 160 and an espresso machine group head. In some embodiments, the portafilter may have a unitary construction with a cone filter 10, or a cone filter may have a unitary attachment portion to attached to a group head in similar fashion as a portafilter.

In some embodiments, the cone filter 100 may be used with an espresso machine that has a low pressure setting or a pulsing water setting, such as by a pulse nozzle 180. As a cone filter typically works with pour over coffee or tea by gravity, the water does not need to be pressurized during brewing. In one example embodiment method, coffee grounds or tea may be placed in the cone filter 100, the cone filter may be placed in a portafilter 160 which is then fixed to the group head. Then the espresso machine can either work in a low pressure setting to provide heated water to the coffee grounds or tea, or can work by pulsing heated water onto the coffee grounds or tea to brew or steep. Also, as a cone filter 100 is a larger volume than a conventional basket filter, an espresso machine may be configured to have a relatively large dose of water to pour over the cone filter. This also allows the final volume of the coffee or tea to be supplied by the espresso machine without having to add water, milk, or other liquids from another source to complete a beverage.

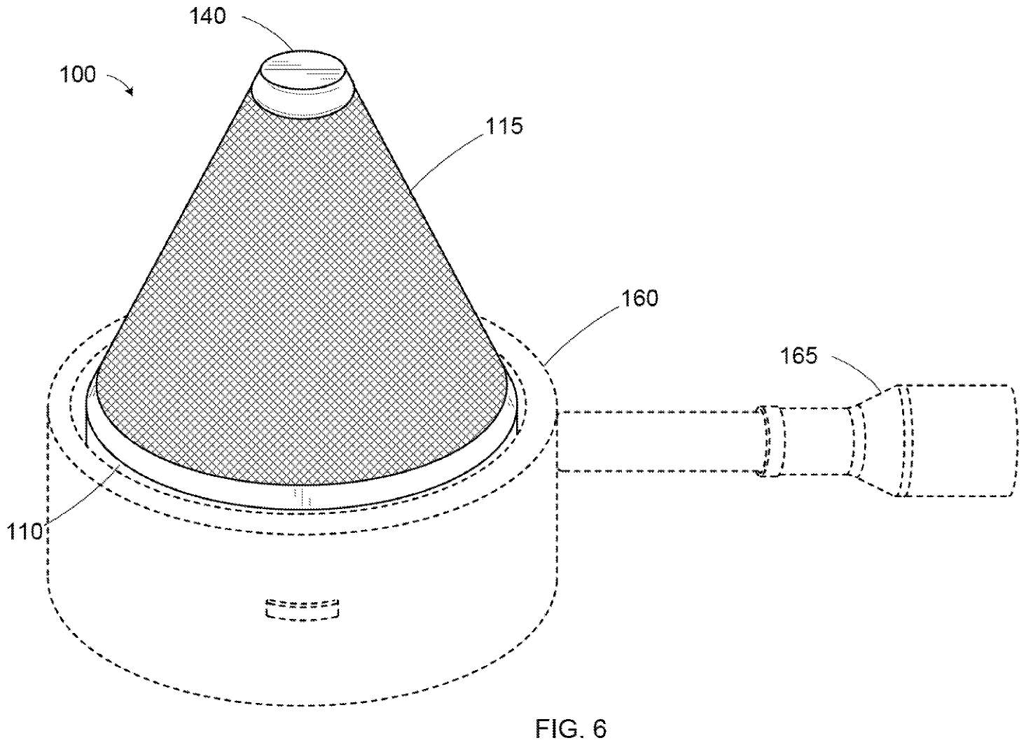

In some embodiments, an espresso machine may have a novel water dispersing mode that provides an overall lower pressure than standard espresso brewing pressures. For example, the machine may provide a duty cycle of water dispersal and resting periods and adjust the dispersal period for a short enough time to not have high peak pressures. As a non-limiting example, the water may be pulsed for 1-1.5 seconds or less by nozzle 180 and have resting periods in between, as shown in FIG. 6. In this example, resting periods may be longer than the dispersal periods, but some embodiments could have similar dispersing and resting periods, or even shorter resting periods if the pressurized water is exhausted.

In another embodiment, an espresso machine can be adapted to use a pre-infusion water dispersion without having a subsequent higher peak water dispersion pressure as in a conventional espresso brewing process. This approach in conjunction with the cone filter disclosed herein would provide a pour over coffee at pressures lower than typical espresso machine brewing pressures. Other embodiments may have 1, 2, or 3 or more phase cycles adapted to disperse water through an embodiments cone filter at water pressures beneficial for pour over coffee as opposed to regular espresso machine brewing pressures. However, regular peak pressures can also be used in embodiments described herein.

In another embodiment, water may be dispersed at line pressure without activating a pump. This approach allows brewing coffee in a cone filter as disclosed herein without having to undergo an exhaust/release cycle to reduce pressure in the group head. In another non-exhausting cycle, an espresso machine cleaning cycle or other non-exhausting cycle can be used in conjunction with the disclosed cone filter to provide coffee similar to a pour over coffee but within a portafilter placed in the sealed brewing chamber in an espresso machine, similar to other embodiments disclosed herein.

These embodiments would allow a portafilter to be removed and the cone filter to be removed by tapping the cone filter out and replacing it with a standard basket filter so that the espresso machine could then be used to make espresso, for example at a higher pressure and in repeated instances. In this way, having the cone filter fixedly attach but also be rimless allows ease of use as well as ease of extraction and replacement. By way of an example, if a cone filter has a standard diameter for a portafilter, such as 58 mm or 53 mm, the cone filter could be used within existing espresso machines. Additionally, the cap of the cone filter may be structurally rigid enough to allow repeated taps for removal of the cone filter from the portafilter. In some embodiments, the cone filter may not have a cap and the mesh portion could extend to the tip of the cone filter. In some embodiments, coffee or tea can be brewed or steeped in an espresso machine using a removable cone filter and at lower pressure or pulsed water settings with a higher volume of heated water.

It will further be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated may be performed in the sequence illustrated, in other sequences, in parallel, or in some cases omitted. Likewise, the order of any of the above-described processes is not necessarily required to achieve the features and/or results of the embodiments described herein, but is provided for ease of illustration and description.

The subject matter of the present disclosure includes all novel and nonobvious combinations and subcombinations of the various processes, systems and configurations, and other features, functions, acts, and/or properties disclosed herein, as well as any and all equivalents thereof

1. An espresso machine cone filter, comprising:
a base having a protruding rim to fit within a portafilter, the protruding rim having a hollow under section to align with the top of the portafilter;
a mesh cone filter fixed to the base on a top end, with mesh cone filter having one or more layers of mesh; and
a robust cap on the cone filter tip to hold the mesh in place and to provide a rigid place to tap the cone filter for removal.

2. The espresso machine cone filter of claim 1, wherein the mesh cone filter has a plurality of mesh layers.
